(19) United States
(12) Patent Application Publication
(10) Pub. No.: US 2026/0252456 A1
(43) Pub. Date: Aug. 27, 2026

(54) INFORMATION PROCESSING DEVICE

(71) Applicant: TOYOTA JIDOSHA KABUSHIKI KAISHA, Toyota-shi (JP)

(72) Inventor: Lei WANG, Toyota-shi (JP)

(73) Assignee: TOYOTA JIDOSHA KABUSHIKI KAISHA, Toyota-shi (JP)

(21) Appl. No.: 19/396,884

(22) Filed: Nov. 21, 2025

(30) Foreign Application Priority Data
Feb. 26, 2025 (JP) 2025-028940

(51) Int. Cl. G06F 11/30

(52) U.S. Cl. CPC G06F 11/3058

(57) ABSTRACT

An execution device of an information processing device executes acquiring a temperature of the information processing device. The execution device executes performing link training again on a condition that a change in which the acquired temperature of the information processing device approaches within a predetermined temperature range is made, the change being made as a value outside the predetermined temperature range by crossing a predetermined threshold value. The execution device executes updating the new setting information calculated by performing the link training again in the storage device.

### CROSS-REFERENCE TO RELATED APPLICATION

This application claims priority to Japanese Patent Application No. 2025-028940 filed on February 26, 2025. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

Japanese Unexamined Patent Application Publication No. 2018-005376 (JP 2018-005376 A) discloses a communication system. The communication system includes a plurality of communication devices, and each of the communication device includes a communication interface. The communication system sets a communication setting value calculated based on a communication test result on the communication interface.

### SUMMARY

In the communication system as disclosed in JP 2018-005376 A, the communication device may set a communication setting value when establishing communication with another communication device that mutually communicates with the communication device. In this case, after the communication is established, a temperature of the communication device may change. When the temperature of the communication device changes, the communication setting value may not be appropriate.

An information processing device that solves the above-described issue is an information processing device that mutually communicates with a counterpart device via a communication bus. The information processing device includes

a communication port to which the communication bus is connected, an execution device, and a storage device.

The storage device stores setting information for communication by the communication port, and the setting information is calculated by link training performed when establishing communication with the counterpart device.

The execution device is configured to

acquire a temperature of the information processing device,

perform the link training again on a condition that the temperature of the information processing device that is acquired changes to cross a threshold value and approach a temperature range that is predetermined, the threshold value being predetermined as a value outside the temperature range, and

update new setting information calculated by performing the link training again and store the new setting information in the storage device.

According to the above-described configuration, after the setting information is calculated by the link training upon the establishment of the communication, the information processing device performs the link training again, provided that the temperature of the information processing device has changed. Then, the new setting information calculated by performing the link training again is updated and the new setting information is stored in the storage device. As a result, the setting information corresponding to a state after the temperature is changed can be used for communication by the communication port. Therefore, even when the temperature of the information processing device is changed, the information processing device can perform communication by using an appropriate communication setting value.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a vehicle including a communication system in one embodiment;

FIG. 2 is a flowchart showing a series of processing performed by an execution device of an information processing device when activation of the information processing device in the same embodiment;

FIG. 3 is a flowchart showing a series of processing including performing link training again performed by the execution device of the information processing device in the same embodiment; and

FIG. 4 is a graph showing an example of a change in a device temperature and a temperature range in the same embodiment.

### DETAILED DESCRIPTION OF EMBODIMENTS

### One Embodiment

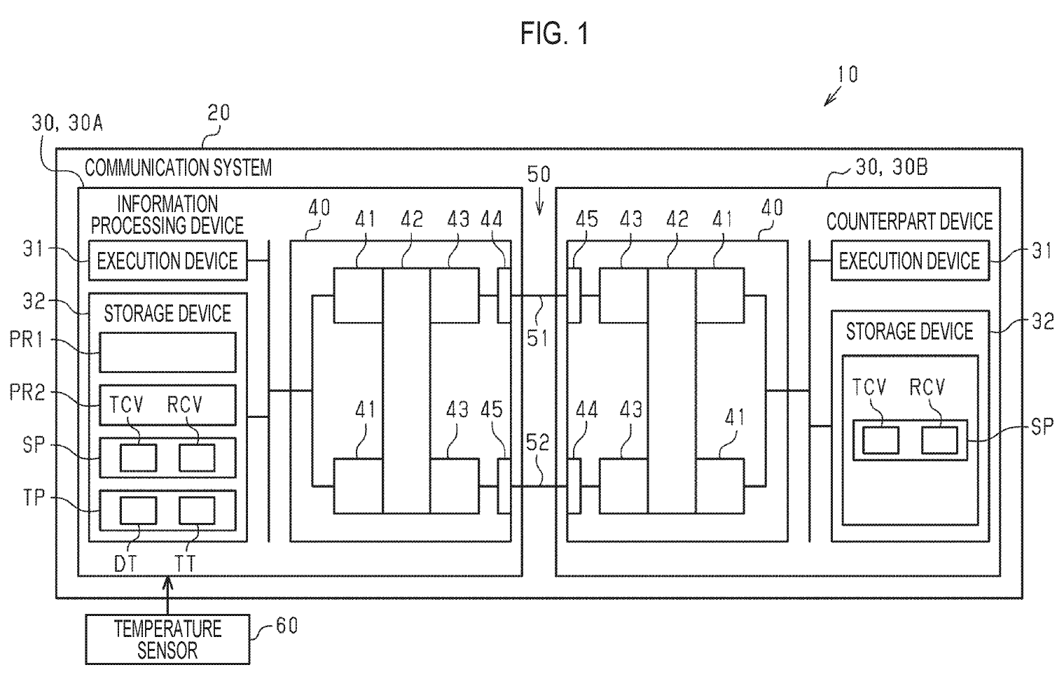

Hereinafter, one embodiment of an information processing device will be described with reference to the drawings. As shown in FIG. 1, a vehicle 10 includes a communication system 20. The communication system 20 acquires a signal from each switch of the vehicle 10 and controls each actuator of the vehicle 10 based on the acquired signal.

The communication system 20 includes a plurality of communication devices 30. The communication devices 30 mutually communicate via a communication bus 50 in accordance with a PCIe standard. PCIe is an abbreviation for Peripheral Component Interconnect express.

The communication device 30 is an ECU that controls each actuator provided in the vehicle 10 or that performs calculation processing based on a value acquired from each sensor provided in the vehicle 10. For example, one of the communication devices 30 is an engine ECU. The engine ECU controls an engine of the vehicle 10. In addition, for example, one of the communication devices 30 is a multimedia ECU. The multimedia ECU controls a display of the vehicle 10 and an audio device of the vehicle 10.

In the present embodiment, the communication devices 30 are two communication devices, that is, an information processing device 30A and a counterpart device 30B. The information processing device 30A is an engine ECU, and the counterpart device 30B is a multimedia ECU. Therefore, the information processing device 30A mutually communicates with the counterpart device 30B via the communication bus 50.

The information processing device 30A functions as a root complex. Meanwhile, the counterpart device 30B functions as an end point. As a result, the information processing device 30A mutually communicates with the counterpart device 30B in accordance with the PCIe standard.

The communication device 30 includes an execution device 31, a storage device 32, and a communication port 40. The execution device 31 is a CPU. Therefore, the execution device 31 includes a processing circuit. The execution device 31 executes various programs stored in the storage device 32 to output an instruction signal for controlling an actuator of the vehicle 10 or to perform various types of calculation processing. For example, in the case of the communication device 30 that is the engine ECU, the execution device 31 outputs an instruction signal for controlling the engine.

The storage device 32 stores setting information SP for the communication port 40 to perform communication in the communication via the communication bus 50.

The setting information SP includes a transmission-side correction value TCV and a reception-side correction value RCV. The transmission-side correction value TCV is a value used for correcting data to be transmitted when the communication port 40 transmits the data. The reception-side correction value RCV is a value used for correcting data to be received when the communication port 40 receives the data.

The communication port 40 is connected to the communication bus 50. The communication port 40 transmits and receives data when performing mutual communication. The communication port 40 includes a transaction layer 41, a data link layer 42, a physical layer 43, a transmitter 44, and a receiver 45. Therefore, the communication port 40 has a three-layer structure.

The transaction layer 41 ensures reliable communication of data in an end-to-end manner with an upper software layer consisting of an upper driver and application software. The transaction layer 41 includes a transaction layer 41 on a transmission side and a transaction layer 41 on a reception side. The transaction layer 41 on the transmission side generates a transaction layer packet in response to a request from the execution device 31. The transaction layer 41 on the reception side receives the transaction layer packet from another communication device 30 that communicates mutually.

The data link layer 42 is located between the transaction layer 41 and the physical layer 43. The data link layer 42 exchanges the transaction layer packet with the communication device 30 that communicates mutually. The data link layer 42 performs flow control. In the flow control, the data link layer 42 limits a transmission speed in accordance with a reception processing speed of the communication device 30 that communicates mutually.

The physical layer 43 transmits and receives a data packet to be communicated on a physical medium. The physical layer 43 includes a physical layer 43 on the transmission side and a physical layer 43 on the reception side. The physical layer 43 on the transmission side transmits the data packet to the transmitter 44. The physical layer 43 on the reception side receives the data packet from the receiver 45.

In the present embodiment, the transmitter 44 of the information processing device 30A is connected to the receiver 45 of the counterpart device 30B via a first lane 51 of the communication bus 50. The receiver 45 of the information processing device 30A is connected to the transmitter 44 of the counterpart device 30B via a second lane 52 of the communication bus 50.

The transmitter 44 transmits data to the other communication device 30 that communicates mutually via the communication bus 50 by using the transmission-side correction value TCV of the setting information SP. The receiver 45 receives the data from the other communication device 30 that mutually communicates via the communication bus 50 by using the reception-side correction value RCV of the setting information SP.

The vehicle 10 includes a temperature sensor 60. The temperature sensor 60 detects a device temperature DT, which is a temperature of the information processing device 30A. The temperature sensor 60 outputs the detected device temperature DT to the information processing device 30A.

The storage device 32 of the information processing device 30A stores an activation program PR1, a temperature change program PR2, and temperature information TP. The activation program PR1 is a program for being executed by the execution device 31 of the information processing device 30A when the information processing device 30A acquires an activation request from a switch (not shown). The temperature change program PR2 is a program for causing the execution device 31 of the information processing device 30A to detect the device temperature DT, which is the temperature T of the information processing device 30A, and to perform processing in accordance with a change in the device temperature DT. The temperature information TP includes time-series data of the device temperature DT and a training temperature TT, which will be described later.

Series of Processing Performed upon Activation of Information Processing Device

Next, a series of processing performed upon activation of the information processing device 30A will be described. When the information processing device 30A acquires the activation request from the switch (not shown), the execution device 31 of the information processing device 30A starts execution of the activation program PR1.

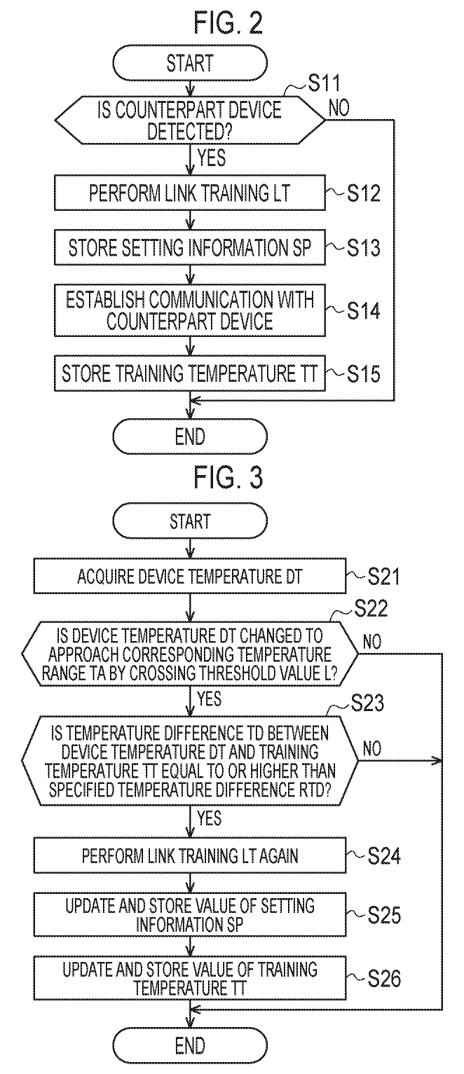

As shown in FIG. 2, when the execution device 31 starts the execution of the activation program PR1, the execution device 31 first performs processing of S11. In S11, the execution device 31 determines whether the counterpart device 30B is detected.

When the counterpart device 30B is not detected (S11: NO), the execution device 31 ends the current series of processing. Meanwhile, when the counterpart device 30B is detected (S11: YES), the execution device 31 proceeds the processing to S12.

In S12, the execution device 31 performs link training LT. The link training LT is processing for establishing communication between the information processing device 30A and the counterpart device 30B by appropriately connecting the information processing device 30A and the counterpart device 30B via communication.

When the execution device 31 starts the link training LT, first, the execution device 31 detects a physical connection of a differential signal in accordance with the PCIe standard. When a response is not obtained from the communication port 40, the execution device 31 determines that a slot that does not respond is not in use.

Next, the execution device 31 starts communication at a minimum speed in a predetermined band. Next, the counterpart device 30B adjusts a correction value of the receiver 45 of the counterpart device 30B to set the reception to be possible without an error. In addition, the execution device 31 adjusts a correction value of the transmitter 44 of the information processing device 30A to set a state in which data can be transmitted from the information processing device 30A to the counterpart device 30B without an error.

Next, the execution device 31 adjusts a correction value of the receiver 45 of the information processing device 30A to set the reception to be possible without an error. Then, the execution device 31 calculates the setting information SP by using, as the transmission-side correction value TCV, the correction value of the transmitter 44 and using, as the reception-side correction value RCV, the correction value of the receiver 45 in a state in which data can be transmitted and received without an error. As described above, the setting information SP is calculated by the adaptive adjustment between the transmitter 44 and the receiver 45. Then, the execution device 31 proceeds the processing to S13.

In S13, the execution device 31 stores the setting information SP calculated by the link training LT in S12 in the storage device 32. Then, the execution device 31 proceeds the processing to S14.

In S14, the execution device 31 starts normal data transmission. That is, since the link training LT is completed to establish the communication between the information processing device 30A and the counterpart device 30B, the execution device 31 starts the normal data transmission in accordance with the request after the processing of S14. Then, the execution device 31 proceeds the processing to S15.

In S15, the execution device 31 acquires the device temperature DT from the temperature sensor 60, and stores the acquired device temperature DT in the storage device 32 as the training temperature TT, which is the temperature T when the link training LT is performed. Thereafter, the execution device 31 ends the current series of processing.

### Series of Processing Including Processing When Temperature Changes

As shown in FIG. 1, after the execution of the activation program PR1 is finished, the execution device 31 repeatedly executes the temperature change program PR2 for each predetermined period.

As shown in FIG. 3, when the execution device 31 starts the execution of the temperature change program PR2, the execution device 31 first performs processing of S21. In S21, the execution device 31 acquires the device temperature DT from the temperature sensor 60. Then, the execution device 31 proceeds the processing to S22.

In S22, the execution device 31 determines whether the device temperature DT has changed to approach within a predetermined temperature range TA across a predetermined threshold value L. In S22, the execution device 31 executes the determination based on the device temperature DT acquired in S21 and the device temperature DT acquired in the past.

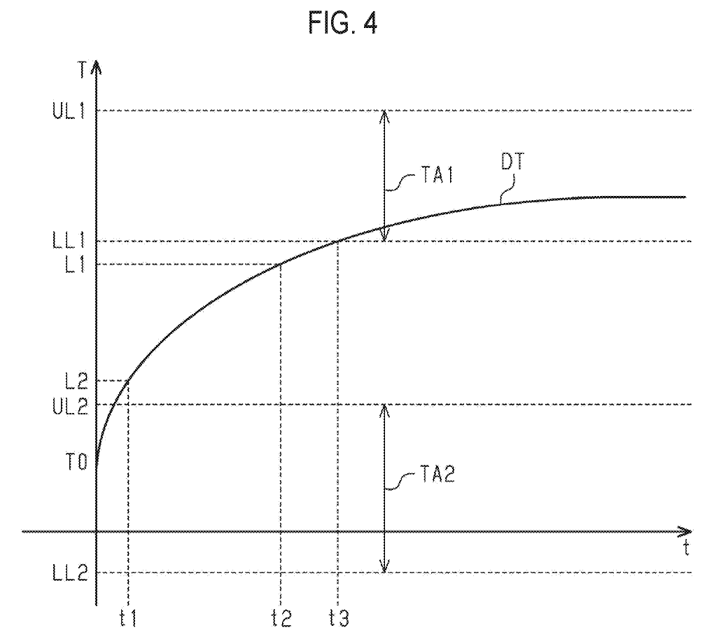

As shown in FIG. 4, the temperature range TA includes a first temperature range TA1 and a second temperature range TA2. The first temperature range TA1 is a temperature range TA that does not overlap the second temperature range TA2 and that is on a higher temperature side than the second temperature range TA2.

The first temperature range TA1 is determined as the temperature range TA in which the temperature T is excessively high and the tolerance for communication via the communication bus 50 is poor. An upper limit temperature UL1 of the first temperature range TA1 is set as a maximum temperature for the device temperature DT. A lower limit temperature LL1 of the first temperature range TA1 is set as a temperature T on a lower limit side at which the tolerance for communication via the communication bus 50 cannot satisfy a predetermined criterion due to the excessively high temperature T.

The second temperature range TA2 is determined as the temperature range TA in which the temperature T is excessively low and the tolerance for communication via the communication bus 50 is poor. A lower limit temperature LL2 of the second temperature range TA2 is set as a minimum temperature for the device temperature DT. An upper limit temperature UL2 of the second temperature range TA2 is set as a temperature T on an upper limit side at which the tolerance for communication via the communication bus 50 cannot satisfy the predetermined criterion due to the excessively low temperature T.

In addition, a first threshold value L1 is predetermined as the threshold value L for the first temperature range TA1. The first threshold value L1 is predetermined as the temperature T that is lower than the lower limit temperature LL1 of the first temperature range TA1 and is higher than the upper limit temperature UL2 of the second temperature range TA2.

A second threshold value L2 is predetermined as the threshold value L for the second temperature range TA2. The second threshold value L2 is predetermined as the temperature T that is higher than the upper limit temperature UL2 of the second temperature range TA2 and is lower than the lower limit temperature LL1 of the first temperature range TA1.

The execution device 31 determines whether the device temperature DT has changed to approach within the first temperature range TA1 across the first threshold value L1, and whether the device temperature DT has changed to approach within the second temperature range TA2 across the second threshold value L2.

For example, when the device temperature DT is changing to increase, the device temperature DT changes to move away from the second temperature range TA2 even when the device temperature DT crosses the second threshold value L2. Therefore, in this case, the execution device 31 determines that the device temperature DT has not changed to approach within the second temperature range TA2 by crossing the second threshold value L2.

When the device temperature DT is changing to increase, in a case in which the device temperature DT crosses the first threshold value L1, the device temperature DT changes to approach within the first temperature range TA1. In this case, the execution device 31 determines that the device temperature DT is changing to approach within the first temperature range TA1 by crossing the first threshold value L1.

Meanwhile, when the device temperature DT is changing to decrease, the device temperature DT changes to move away from the first temperature range TA1 even when the device temperature DT crosses the first threshold value L1. Therefore, in this case, the execution device 31 determines that the device temperature DT has not changed to approach within the first temperature range TA1 by crossing the first threshold value L1.

When the device temperature DT is changing to decrease, in a case in which the device temperature DT crosses the second threshold value L2, the device temperature DT changes to approach within the second temperature range TA2. In this case, the execution device 31 determines that the device temperature DT is changing to approach within the second temperature range TA2 by crossing the second threshold value L2.

That is, in S22, the execution device 31 makes a determination to be positive in the following case: a case in which the device temperature DT has changed to approach within the first temperature range TA1 by crossing the first threshold value L1; or a case in which the device temperature DT has changed to approach within the second temperature range TA2 by crossing the second threshold value L2. Meanwhile, in S22, the execution device 31 makes a determination to be negative in the following case: a case in which the device temperature DT has not changed to approach within the first temperature range TA1 by crossing the first threshold value L1; and a case in which the device temperature DT has not changed to approach within the second temperature range TA2 by crossing the second threshold value L2.

As shown in FIG. 3, when the device temperature DT has not changed to approach the temperature range TA corresponding to the threshold value L by crossing the threshold value L (S22: NO), the execution device 31 ends the current series of processing. Meanwhile, when the device temperature DT has changed to approach the temperature range TA corresponding to the threshold value L by crossing the threshold value L (S22: YES), the execution device 31 proceeds the processing to S23.

In S23, the execution device 31 determines whether a temperature difference TD between the device temperature DT acquired in S21 and the training temperature TT is equal to or higher than a predetermined and specified temperature difference RTD. The specified temperature difference RTD is determined as a difference in the temperature T at which the setting information SP is to be updated, in advance through a test or a simulation.

When the temperature difference TD is lower than the specified temperature difference RTD (S23: NO), the execution device 31 ends the current series of processing. Meanwhile, when the temperature difference TD is equal to or higher than the specified temperature difference RTD (S23: YES), the execution device 31 proceeds the processing to S24.

In S24, the execution device 31 performs the link training LT again. That is, the execution device 31 performs the link training LT again on a condition that the device temperature DT has changed to approach the corresponding temperature range TA by crossing the threshold value L and the temperature difference TD is equal to or higher than the specified temperature difference RTD. In S24, the same processing as in S12 is performed again. Therefore, since the detailed contents of the processing are the same as those in S12, the detailed description thereof will be omitted. When the execution device 31 calculates the setting information SP by performing the link training LT again, the execution device 31 proceeds the processing to S25.

In S25, the execution device 31 updates a value of the setting information SP stored in the storage device 32 to the value of the setting information SP calculated in S24, and stores the updated value. Then, the execution device 31 proceeds the processing to S26.

In S26, the execution device 31 updates a value of the training temperature TT stored in the storage device 32 to the value of the device temperature DT acquired in S21, and stores the updated value. Thereafter, the execution device 31 ends the current series of processing.

### Actions of Present Embodiment

A case will be described in which the vehicle 10 in a state of being sufficiently cooled is started and the communication system 20 is activated.

As shown in FIG. 4, when the vehicle 10 is started, the device temperature DT is a temperature T0. The temperature T0 is a temperature T lower than the upper limit temperature UL2 of the second temperature range TA2. Thereafter, when time t reaches time t1, the device temperature DT exceeds the upper limit temperature UL2 to be the second threshold value L2. Thereafter, in a case in which the vehicle 10 is further used, when time t reaches time t2, the device temperature DT is the first threshold value L1. Thereafter, in a case in which the vehicle 10 is further used, the device temperature DT approaches within the first temperature range TA1 until time t reaches time t3. Thereafter, when time t reaches time t3, the device temperature DT is the lower limit temperature LL1 of the first temperature range TA1. Thereafter, the device temperature DT is the temperature T within the first temperature range TA1.

In this case, when the execution device 31 executes the temperature change program PR2 after time t2 and before time t3, the determination result in the processing of S22 is positive. In addition, since the temperature difference TD between the temperature T0 and the lower limit temperature LL1 of the first temperature range TA1 is equal to or higher than the specified temperature difference RTD, the execution device 31 performs the link training LT again in S24. As a result, the setting information SP is updated to a value calculated by the link training LT performed when the device temperature DT is the temperature T that is higher than the first threshold value L1 and lower than the lower limit temperature LL1 of the first temperature range TA1.

### Effects of Present Embodiment

(1) The execution device 31 of the information processing device 30A performs the link training LT again on a condition that the acquired device temperature DT has changed to approach within the temperature range TA by crossing the threshold value L. Then, the execution device 31 updates the new setting information SP calculated by performing the link training LT again in the storage device 32.

According to the above-described configuration, after the setting information SP is calculated by the link training LT when the communication is established, the information processing device 30A performs the link training LT again, provided that the device temperature DT has changed. Then, the information processing device 30A updates the new setting information SP calculated by performing the link training LT again in the storage device 32. As a result, the information processing device 30A can use the setting information SP corresponding to a state after the device temperature DT is changed, for communication by the communication port 40. Therefore, even when the device temperature DT is changed, the information processing device 30A can perform communication by using an appropriate communication setting value.

(2) The storage device 32 stores the training temperature TT when the setting information SP is stored. The execution device 31 updates the training temperature TT in the storage device 32 when the link training LT is performed. The execution device 31 performs the link training LT again on an additional condition that the temperature difference TD between the device temperature DT and the training temperature TT is equal to or higher than the predetermined and specified temperature difference RTD.

According to the above-described configuration, the execution device 31 performs the link training LT again on an additional condition that the temperature difference TD between the device temperature DT and the previous training temperature TT is equal to or higher than the specified temperature difference RTD. Therefore, when the appropriate setting information SP is significantly changed by the change in the device temperature DT, the information processing device 30A can update the setting information SP.

(3) The setting information SP includes the transmission-side correction value TCV and the reception-side correction value RCV. The transmission-side correction value TCV is used for correcting data when the communication port 40 transmits the data. The reception-side correction value RCV is used for correcting data when the communication port 40 receives the data. According to the above-described configuration, the information processing device 30A can correct the data by using the appropriate setting information SP in both a case of transmitting and a case of receiving.

(4) The communication between the counterpart device 30B and the communication bus 50 is communication in accordance with the PCIe standard. Therefore, by using, as the link training LT, a function performed by a root complex in accordance with the PCIe standard, a developer of the information processing device 30A does not need to separately develop the processing content of the link training LT.

### Modification

The embodiment described above can be modified and carried out as follows. The embodiment described above and the following modifications can be carried out in combination within a technically consistent range.

The storage device 32 may not store the training temperature TT. The execution device 31 may not execute updating the training temperature TT in the storage device 32 when the link training LT is performed. The link training LT may not be performed on an additional condition that the temperature difference TD between the device temperature DT and the training temperature TT is equal to or higher than the predetermined and specified temperature difference RTD. That is, the execution device 31 may omit the processing of S23 and S26.

The setting information SP may not include the transmission-side correction value TCV and the reception-side correction value RCV. For example, the setting information SP may include only one of the transmission-side correction value TCV or the reception-side correction value RCV. In addition, for example, the setting information SP may include a continuous time linear equalizer (CTLE) for emphasizing a high-frequency component to correct the signal. In addition, for example, the setting information SP may include decision feedback equalization (DFE) for correcting an error by using the previous bit information. In addition, for example, the setting information SP may include a finite impulse response (FIR) filter for performing digital filtering to optimize the signal.

The communication between the counterpart device 30B and the communication bus 50 need not be communication in accordance with the PCIe standard.

· The temperature range TA may not include the first temperature range TA1 and the second temperature range TA2. The temperature range TA may be only one of the first temperature range TA1 or the second temperature range TA2.

The information processing device 30A and the ECU of the counterpart device 30B are not limited to the examples of the embodiment described above. The information processing device 30A may be, for example, an engine ECU or a multimedia ECU as long as the information processing device 30A is a communication device that mutually communicates with the counterpart device 30B. Similarly, the counterpart device 30B may be, for example, a body ECU or a memory card as long as the counterpart device 30B is a communication device that mutually communicates with the information processing device 30A.

The information processing device 30A may be configured as a circuit (circuitry) including one or more processors that execute various types of processing in accordance with a computer program (software). The information processing device 30A may be configured as a circuit including one or more dedicated hardware circuits, such as an application-specific integrated circuit (ASIC), which executes at least a part of various types of processing, or a combination thereof. The processor includes a CPU and a memory, such as a RAM and a ROM. The memory stores a program code or an instruction configured to cause the CPU to execute the processing. The memory, that is, a computer-readable medium includes any usable medium accessible by a general-purpose or dedicated computer. The same applies to the counterpart device 30B.

What is claimed is:

1. An information processing device that mutually communicates with a counterpart device via a communication bus, the information processing device comprising:
a communication port to which the communication bus is connected;
an execution device; and
a storage device, wherein
the storage device stores setting information for communication by the communication port, the setting information being calculated by link training performed when communication with the counterpart device is established, and
the execution device is configured to
acquire a temperature of the information processing device,
perform the link training again on a condition that the temperature of the information processing device that is acquired changes to cross a threshold value and approach a temperature range that is predetermined, the threshold value being predetermined as a value outside the temperature range, and
update new setting information calculated by performing the link training again and store the new setting information in the storage device.

2. The information processing device according to claim 1, wherein:
the storage device stores a training temperature when the setting information is stored; and
the execution device is configured to
update the training temperature and store the training temperature in the storage device when the link training is performed, and
perform the link training again on an additional condition that a temperature difference between the temperature of the information processing device and the training temperature is equal to or larger than a specified temperature difference that is predetermined.

3. The information processing device according to claim 1, wherein the setting information includes a transmission-side correction value for correcting data when the communication port transmits the data, and a reception-side correction value for correcting data when the communication port receives the data.

4. The information processing device according to claim 1, wherein communication with the counterpart device via the communication bus is PCIe-compliant communication.
